(19) United States
(12) Patent Application Publication
(10) Pub. No.: US 2008/0223066 A1
(43) Pub. Date: Sep. 18, 2008

(54) FREEZING RECEPTACLE AND APPARATUS

(76) Inventors: Colin Henderson, London (CA); Eduardo KRUPNIK, Mississauga (CA); Todd Copeland, Ilberton (CA); Claire Temple-Oberle, London (CA)

Correspondence Address: BERESKIN AND PARR, 40 KING STREET WEST, BOX 401, TORONTO, ON, M5H 3Y2, CA

(21) Appl. No.: 12/046,746

(22) Filed: Mar. 12, 2008

Related U.S. Application Data
(60) Provisional application No. 60/894,567, filed on Mar. 13, 2007.

(51) Int. Cl. F25D 23/12; B65D 81/38; F28F 7/00; G09F 3/00

(52) U.S. Cl. 62/331; 220/592.2; 165/80.1; 40/299.01

(57) ABSTRACT

Various embodiments for a freezing receptacle and apparatus are described. The freezing receptacle includes a freezing box with a thermal agent that serves to freeze or cool an object or maintain the temperature of the object. The freezing receptacle includes at least one side wall having a sloped inner face that slopes inwards to ensure that the thermal agent remains in thermal contact with the object continuously as the thermal agent changes size and at least one side wall with a vertical face or an outer face that slopes outwards.

### REFERENCE TO RELATED APPLICATION

This application claims priority from U.S. Provisional Patent Application Ser. No. 60/894567 filed on Mar. 13, 2007.

### FIELD

Embodiments described herein relate generally to receptacles used to freeze or cool objects or maintain those objects at a certain temperature with the aid of a thermal agent.

### BACKGROUND

Receptacles for maintaining contents below or above ambient temperature, such as polypropylene and polystyrene receptacles are common in the art. These receptacles typically comprise rectilinear, rigid, insulated-walled boxes. If the objective is to maintain the contents below ambient temperature or to freeze the contents, a cooling or freezing agent is placed inside the receptacle chamber in close proximity to the objects being refrigerated or frozen. Since the inside walls of the chamber are rectilinear, air gaps tend to appear between the item and the cooling or freezing agent as the freezing agent melts or reduces in size, reducing the thermal contact between the object and the freezing agent. This results in the object being irregularly frozen as sections of it are in contact with the freezing agent while other sections are not.

### SUMMARY

The embodiments described herein relate to receptacles and methods for using the receptacles. At least one embodiment described herein relates to such a receptacle having sloped inner walls to assist in keeping a thermal agent in contact with the object during use. The embodiments described herein may be applied in various fields including the fields of tissue sample preparation.

In one aspect, at least one embodiment of the invention provides a receptacle for freezing, cooling or maintaining the temperature of an object placed within the receptacle. The receptacle comprises a base comprising a bottom surface and side walls and being adapted to receive the object, the bottom surface and side walls having an outer face and an inner face, at least one of the inner faces on the side walls being sloped at a first angle greater than 90° relative to the bottom surface, and at least one of the outer faces of the side walls being vertical or sloped at a second angle less than 90° relative to the bottom surface. The receptacle further comprises a lid for covering the base. The base and the lid define a chamber and at least one portion of the chamber defined by the object and the at least one sloped inner face of the side walls is adapted for receiving and maintaining a thermal agent in contact with the object during use.

The receptacle can be portable.

In at least some cases, the base comprises four side walls with each side wall having a sloped inner face.

The first angle of the sloped inner face can be between about 120° and about 160°. Alternatively, the first angle of the sloped inner face can be between about 130° and about 150°.

At least one of the outer walls can be vertical with respect to the base. Alternatively, at least one of the outer walls can be sloped in an outward direction. The second angle of the sloped outer face is between about 40° and 90°. These various arrangements provide a wider, more stable base for the receptacle.

In at least some cases, the inner face of the bottom surface comprises shoulders for receiving the object. In these cases, the bottom shoulders may have a height so that the upper surface of the object is at or below the uppermost portion of the sloped wall.

The lid comprises first and second surfaces. The base comprises a first securing means and the first surface of the lid and the second surface of the lid comprise complementary second securing means and third securing means respectively for releasably engaging the first securing means when either the first surface of the lid or the second surface of the lid is placed on the base.

In at least some cases, the first surface of the lid is adapted to cover the base and provide for a space between the object and the first surface of the lid, and the second surface of the lid is adapted to cover the base and restrict the space between the object and the second surface of the lid.

In at least one embodiment, at least one of the surfaces of the lid acts as a tray.

In at least one embodiment, at least one of the surfaces of the lid acts as working platform.

In at least one embodiment, the receptacle further comprises an insert made of a thermo-insulating material to fill the space between the object and one of the side walls or the lid. In at least one embodiment, the insert has an upper surface that lies at or below the upper surface of the object.

In at least one embodiment, the object has a thermal inertia that can be maintained through continuous contact with the thermal agent.

In at least one embodiment, the object is a freezing platform. The freezing platform can have one of a rectangular, elliptical and circular shape.

In at least one embodiment, the receptacle is integrally formed from a thermo-insulating material. The thermal insulating material may comprise polypropylene or polystyrene or any other suitable thermal insulating material.

In at least some embodiments, the at least one sloped inner face is formed integrally with a corresponding side wall. Alternatively, in at least some embodiments, the receptacle further comprises a vertical side wall with a vertical inner face and a sloped insert with a corresponding vertical face placed adjacent to the vertical side wall and an opposing sloped face to provide the at least one sloped inner face.

In at least one embodiment, at least one of the surfaces of the lid is covered by a material suitable to serve as a cutting board.

According to another aspect, at least one embodiment of the invention provides a lid for covering the base of a receptacle. The lid comprises a first surface and a second surface, wherein both the first and second surfaces of the lid are designed to cover the base of the receptacle.

The base of the receptacle comprises a first securing means, and the first side and the second surfaces of the lid comprise a complementary second and third securing means sized for releasably engaging the first securing means when either the first surface of the lid or the second surface of the lid is placed on the base.

In at least some cases, the first and second surfaces of the lid have different heights for providing different sized chambers depending on the surface that faces the receptacle when the lid is placed on the receptacle.

The lid can be integrally formed from a thermo-insulating material.

According to another aspect, at least one embodiment of the invention provides an apparatus for preparing a frozen tissue sample from an excised tissue sample. The apparatus comprises a receptacle as described above. The apparatus also includes at least one sample receptacle for receiving the excised tissue sample and the embedding material and at least one chuck.

The sample receptacle includes a well having a flat base, walls and flat flanges connected at the upper portion of the walls to define a flat surface for the sample receptacle. The chuck has a textured surface for placement on the flat flanges of the sample receptacle.

The freezing platform can have a rectangular, elliptical or circular shape.

According to another aspect, at least one embodiment of the invention provides a chuck for preparing tissue samples. The chuck comprises a top portion having an upper surface and a lower surface; and a post mounted on the lower surface of the top portion. The top portion comprises an area on at least one of the upper and lower surfaces suitable for writing, marking or affixing information. The dimensions of the top portion approximately match the outer flange dimensions of a sample receptacle.

In at least some cases, the chuck further comprises a groove around at least a portion of the circumference of the top portion.

According to another aspect, at least one embodiment of the invention provides a tag that can be mounted on or attached to a chuck. The tag is suitable for writing, marking or affixing information.

### BRIEF DESCRIPTION OF THE DRAWINGS

For a better understanding of various embodiments of the invention and to show more clearly how they may be carried into effect, reference will now be made, by way of example only, to the accompanying drawings which show at least one exemplary embodiment of the invention and in which:

FIG. 1A is a cross-sectional view of an apparatus, including exemplary embodiments of a freezing receptacle, sample container and chucks, for preparing a frozen tissue sample;

FIGS. 1B and 1C are cross-sectional views of an alternative embodiment of the apparatus with alternative freezing receptacles;

FIGS. 2A-2B are partial cross-sectional views of the receptacle of FIG. 1A with the lid of the receptacle in first and second positions respectively;

FIGS. 3A-3B are partial cross-sectional views of another embodiment of the receptacle with the lid of the receptacle in first and second positions respectively;

FIGS. 4A-4D are partial cross-sectional views of the base of alternative embodiments of the receptacle;

FIGS. 5A-5D are partial cross-sectional views of the base of alternative embodiments of the receptacle;

FIG. 6 is a top view of an alternative embodiment of a chuck;

FIG. 7 is a perspective view of the chuck of FIG. 6;

FIG. 8 is a bottom view of another alternative embodiment of a chuck with a tag mounted on the chuck; and

FIGS. 9-11 are side, end and top views of another alternative embodiment of a chuck.

### DETAILED DESCRIPTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments of the invention described herein. Some features in the figures have not been drawn to scale. Further, it should be understood by those of ordinary skill in the art that the embodiments described herein may be practiced without these specific details. In other instances, well-known methods, procedures and components have not been described in detail so as not to obscure the embodiments described herein. Furthermore, this description should not to be considered as limiting the scope of the embodiments described herein, but rather as merely describing the implementation of the various embodiments described herein.

Various embodiments described herein provide a freezing receptacle having at least one side wall that is sloped on the inside of the receptacle so that as a thermal agent, placed within the receptacle melts, evaporates or otherwise changes size, the remainder of the thermal agent will tend to slide against the object thus continuously affecting the temperature of the object. Shoulders may also be provided in the base of the receptacle that serve to anchor an object to be frozen or cooled in the freezing receptacle.

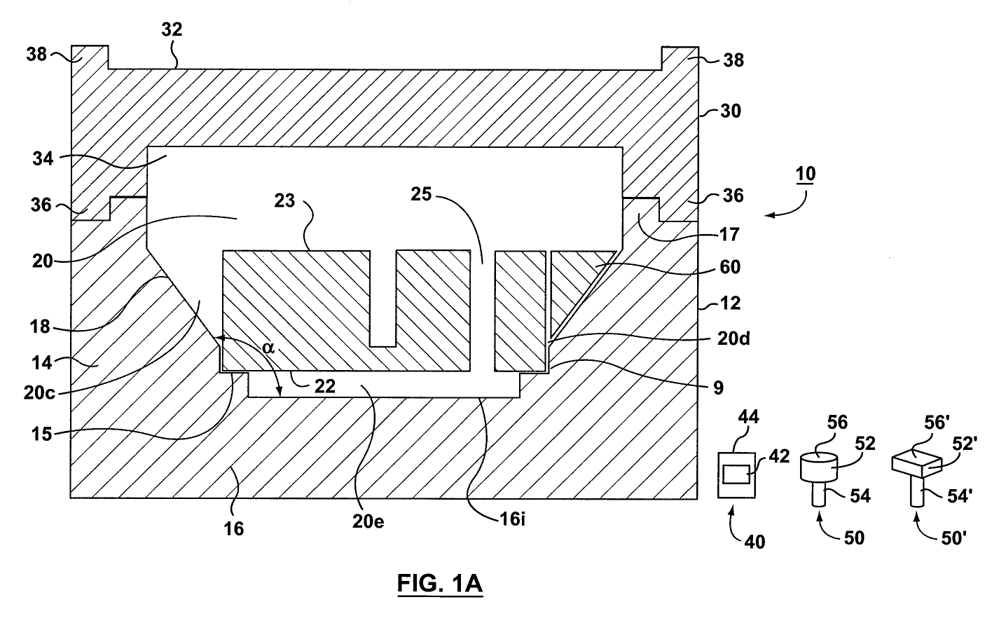

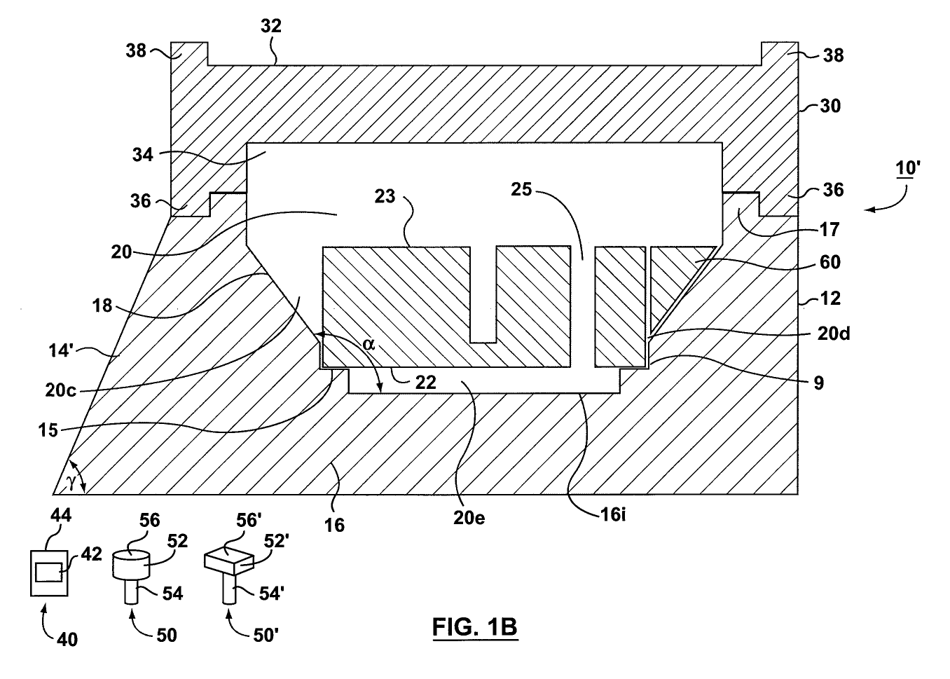

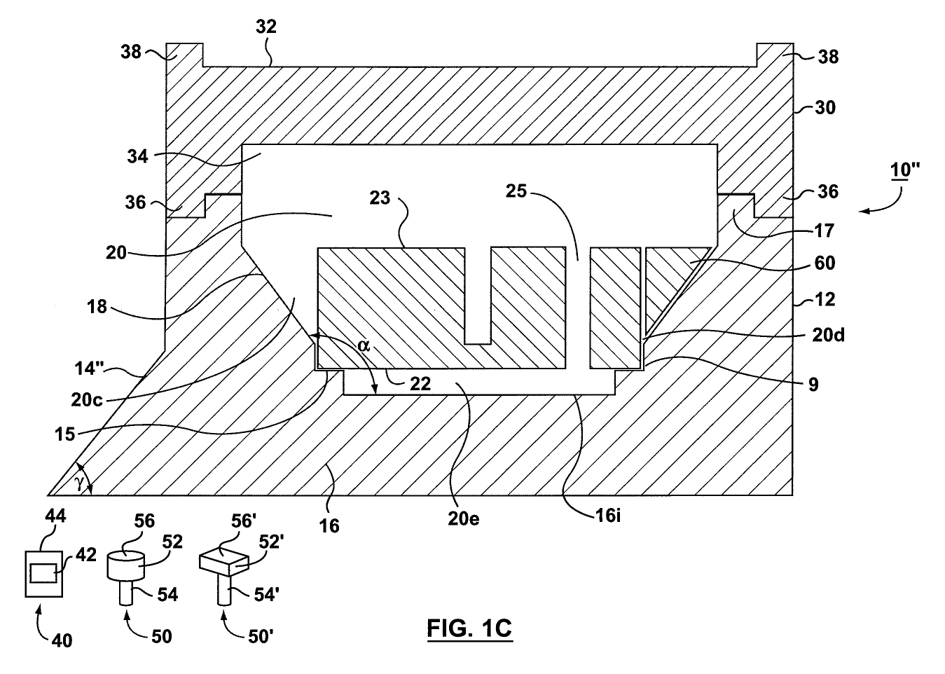

In addition, at least one of the outer side walls is vertical as shown in FIG. 1A to provide for a more stable base. There can also be embodiments in which all external faces of the side walls are vertical. Alternatively, there can be embodiments in which the external face of at least one of the side walls is sloped as shown in FIGS. 1B and 1C. The slope of an external face of the side wall can begin from the top of the base 14 (FIG. 1B) or from a point below the top of the base 14 (FIG. 1C). The sloped external face of the side wall provides a wider, more stable base in order to prevent the receptacle 10′, 10″ from tipping over. The slope of the external face of the side wall is generally in an opposite direction compared to the sloped inner face 18. The slope γ is defined with respect to the bottom surface of the base 14 and can range from about 40° to under 90°. Although not shown, there can be embodiments in which all of the external faces of the side walls are sloped. There can also be embodiments (not shown) in which some of the external faces of the side walls are vertical and other external faces of the side walls are sloped.

In addition, in at least some embodiments, the object 22 can be maintained at the middle of the receptacle in order to take full advantage of the thermal agent by placing several pieces of the thermal agent around the object 22. Also, the bottom surface of the receptacle can be arranged to keep the upper working surface of the object level which is useful for certain applications.

Referring to FIGS. 1-4, shown therein is a cross-sectional view of an embodiment of a receptacle that can be used to freeze or cool an object 22 or to keep the object 22 cold by maintaining the cold temperature. The receptacle 10 includes a base 12 and a lid 30. The base 12 includes a bottom surface 16 and side walls 14. The bottom surface 16 and the side walls 14 possess inner and outer or external faces. The bottom surface 16 possesses inner face 16i, while the side walls 14 possess inner faces 18. The base 12 has four side walls 14, thereby forming a square or rectangle. It will be understood by those skilled in the art however, that the shape of the receptacle is not limited to a square or rectangle and accordingly there can be embodiments that have more or less than four side walls. Furthermore, it should be noted that there can be circular or elliptical embodiments of the freezing receptacle with one continuous side wall and the aspects of the various embodiments described herein can be adapted for such embodiments through appropriate changes in shape. For example, the inner walls of the freezing receptacle 10 can be rectangular, circular, elliptical and the like to accommodate the shape of the object 22 which can have a rectangular, circular or elliptical shape. However, there can also be embodiments in which the object 22 and the walls of the freezing receptacle 10 do not have complimentary shapes if the gaps between the object 22 and the freezing receptacle 10 are large enough. In all of these cases, the thermal agent 60 can also have a shape that corresponds to the shapes of the freezing receptacle 10 and the object 22. It should also be noted that the object 22 can be a freezing platform as is discussed further below.

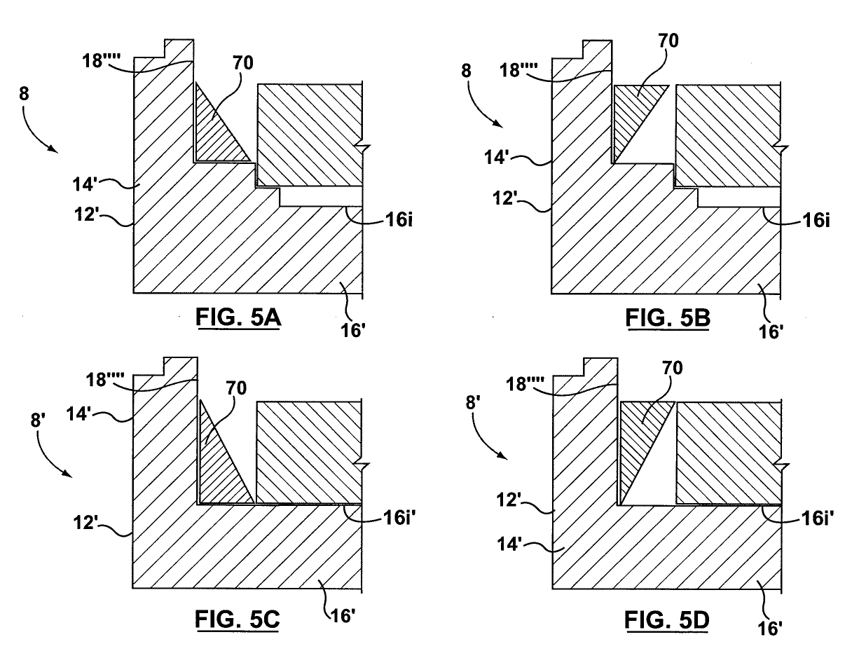

In at least some embodiments, the bottom surface 16 and the side walls 14 are integrally formed from a single piece of thermo-insulating material. In addition, the lid 30 is also formed from a single piece of thermo-insulating material. In other embodiments, the slope can be provided by additional inserts which is described further below in relation to FIGS. 5A-5D.

At least one of the inner surfaces 18 of the side walls 14 is oriented or sloped at an angle a defined between the inner face 16i of the bottom surface 16 and the sloped inner face 18 of the side wall 14. In some cases, two or more of the inner faces 18 of the side walls 14 are sloped. In some case, all side walls 14 of the receptacle 10 have sloped inner walls. The angle α is generally greater than 90 degrees and less than 180 degrees. The angle α can be between about 110° and about 150°. Alternatively, the angle α can be between about 125° and about 140°. Alternatively, the angle α can be between about 120° and about 160°. Alternatively, the angle α can be between about 130° and about 150°.

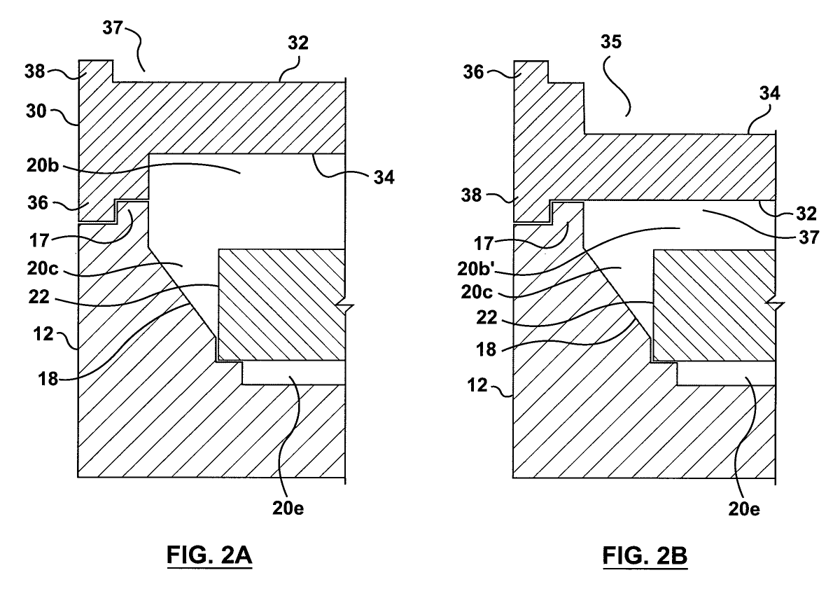

The region between the bottom surface 16, side walls 14, the object 22 and the lid 30 define a freezing or cooling chamber 20 or compartment. As seen in FIGS. 2A and 2B, a gap or chamber portion 20c is defined by the sloped inner face 18 of the side walls 14 and object 22. The chamber portion 20c is adapted for receiving a thermal agent 60. The sloped inner faces 18 of the side walls 14 therefore allow the thermal agent 60 to be in direct contact with the object 22. If the thermal agent 60 is an insulating agent, then this structure allows for maintenance of the temperature of the object 22. If the thermal agent 60 is a freezing agent, then this structure allows for continuous cooling or freezing of the object 22. For example, when the thermal agent 60 is dry ice, blocks of dry ice can be placed in the chamber portion 20c to freeze or cool the object 22 by direct contact with the object 22. As the dry ice sublimes (i.e. is converted from a solid to a gas), the remaining solid dry ice will continuously slide down the inner sloped face 18, therefore constantly remaining in contact with the object 22.

The thermal agent 60 can be a freezing agent such as dry ice, which comes in several forms such as blocks, slabs, “popcorn” and pellet. Alternatively, the thermal agent 60 can be an insulating agent that maintains the temperature of the freezing receptacle 10. The insulating agent can comprise polypropylene or polystyrene or any other suitable thermal insulating material.

It should be noted that there can be more than one gap between the object 22 and a sloped wall within which a thermal agent 60 can be placed. For example, there can be some embodiments in which there are gaps and sloped faces on three or more sides of the object 22. Accordingly, in these embodiments it is possible to put more than one thermal agent 60 within the receptacle 10. In addition, in these various embodiments it is possible to use an object that has a thermal inertia that can be maintained through continuous contact with the thermal agent 60.

The inner surface 16i of the bottom surface 16 includes bottom shoulders 15 to support the object 22 being frozen or cooled and provides for a gap 20e underneath the object 22. The height of the bottom shoulders 15 can be selected so that the top surface 23 of the object 22 is approximately at or below the upper level of the slope of the inner faces 18 of the side walls 14. The width of the bottom shoulders 15 provides enough support for the item 22 being frozen or cooled.

In other embodiments in which the base 12 does not have shoulders 15, the base 12, the side walls 14, the sloped inner faces and the thermal agent 60 can be sized so that the thermal agent 60 has an upper surface which lies at or below the upper surface 23 of the object 22.

In at least some embodiments, as seen in FIGS. 1 and 2A-2B, the object 22 is smaller than the freezing chamber 20 so that there are also gaps 20b, 20d and 20e when the object 22 is placed within the freezing chamber 20. The object 22 or the receptacle can be sized so that these gaps are large enough to accommodate the thermal agent 60. The object 22 can also be sized so that some edges of the object 22 contact corresponding sides 9 of the shoulders 15, as seen in FIG. 1. This anchors the object 22 within the base 12. Alternatively, in some cases, a gap can be filled with an insulating agent if there is not enough pieces of the thermal agent 60 to fill the gaps. This will reduce the amount of open space (i.e. air gaps) which will further improve the rate at which the object 22 is cooled or the ability to maintain the object 22 at a certain temperature. For instance, in FIG. 1A, the gap 20c can be filled with an insulating agent.

In at least some cases, the object 22 is a freezing platform for the preparation of frozen tissue samples. The freezing platform can be comprised of aluminum or any other thermally conductive material be it metal, metal alloy, or synthetic. Methods for preparing frozen tissue samples are described in International Publication No. WO 2007/028243, the disclosure of which is incorporated herein by reference.

The base 12 and lid 30 may be made from polypropylene or a polystyrene. In other implementations, a hard shell insulated material may be used such as a carbon composite, silica fiber tile, fiber reinforced polymers and/or a ceramic. In other embodiments, other materials that can provide suitable insulation can also be used such as polyurethane or polyethylene thermoplastics.

As seen in FIGS. 1 and 2A-2B, the lid 30 has a first surface 32 and a second surface 34. Both first surface 32 and second surface 34 of the lid 30 are designed to releasably engage the base 12 and cover the base 12 thereby creating the chamber 20. The sloped inner faces 18 of the side walls 14 end in a first securing means 17. The first securing means 17 is sized for releasably engaging a complementary second securing means 36 on the first surface 32 of the lid 30 and a complementary third securing means 38 on the second surface 34 of the lid 30. It should be noted that various types of securing means can be used such as any complimentary pattern of ridges and channels or dowels and recesses. In some cases, latches or buckles can also be used as the securing means.

The second securing means 36 and the third securing means 38 define a first well 35 and a second well 37, respectively, as seen in FIG. 2A and FIG. 2B. When the first surface 32 or second surface 34 of the lid 30 is not engaged with the base 12, the wells 35 or 37 may serve as trays, which can be used to carry tools. Wells 35 or 37 may be covered by any suitable material suitable to serve as a tray. In addition or in an alternative, wells 35 or 37 may also hold or have an integral board composed of material suitable for cutting or working on. When used to cover base 12, the wells 35 or 37 serve to provide different sized gaps 20b, or no gap at all, between the object 22 and the lid 30. The size of the gap 20b will depend on which surface of the lid 30 is used to cover the base 12 and the shape of each the surfaces of the lid 30. The gap 20b may be useful when the object 22 needs extra space to fit within the chamber 20.

As seen in FIG. 2A, when the first surface 32 of the lid 30 is used to cover the base 12 of the receptacle 10, the gap 20b is larger than the gap 20b′ created when the second surface 34 of the lid 30 is used to cover the base 12 of the receptacle 10 as seen in FIG. 2B.

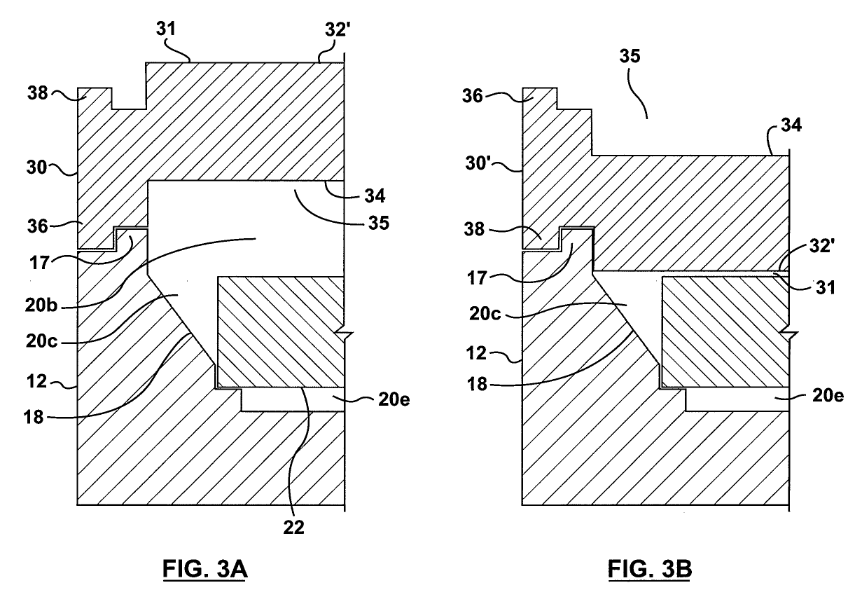

As seen in FIGS. 3A and 3B, another embodiment of the lid 30′ is described. In this aspect, the first surface 32′ of the lid 30′ further includes a platform 31. The platform 31 may serve as a working or cutting board. For example, the platform 31 may be covered by a suitable material, such as plastic or metal, suitable to serve as a working or cutting board. In an alternative embodiment, the platform 31 serves to fill the gap 20b between the object 22 and the lid 30′ when the first surface 32′ of the lid 30′ faces the base 12. In this aspect, the gap 20b is completely occupied by platform 31, which may be useful when enough pieces of a suitable thermal agent 60 are not available. In this case, object 22 may be kept in a common freezer until the temperature of the object 22 is reduced. For example, a common ultra low (−70° Celsius) freezer can be used. In the absence of the thermal agent 60, the reduced temperature of object 22 can be maintained for a longer period of time if the gap 20b is filled. In this aspect, one or more gaps 20c and 20d may also be filled with insulating agents.

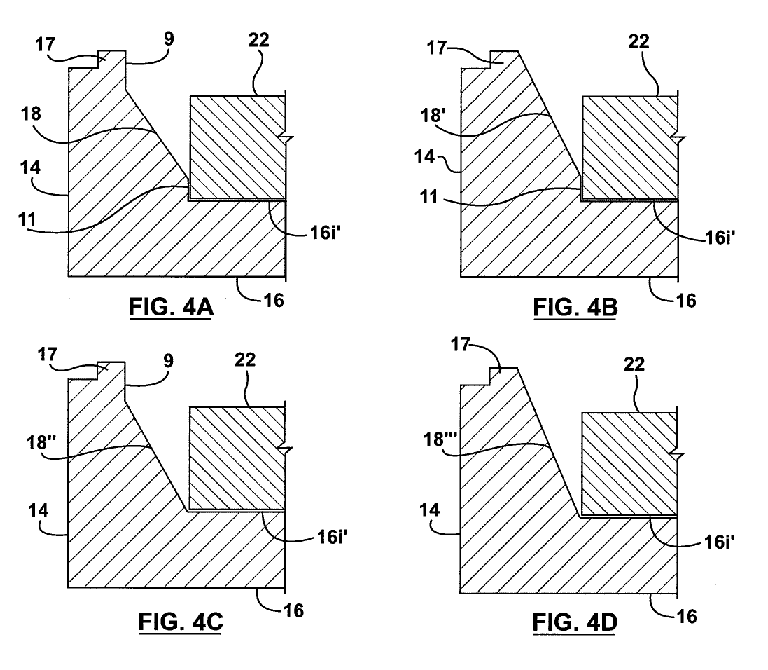

FIGS. 4A-4D show one side of the cross sectional side views of different embodiments of the receptacle. In one embodiment (FIG. 4A), the sloped inner face 18 of the side walls 14 extends from the top of the sidewall 11 to almost the first securing means 17 at the top of sidewall 9. In this case, object 22 rests on top of the inner surface 16i′ of bottom surface 16 and gap 20e is absent. In another embodiment (FIG. 4B), sloped inner face 18′ extends from the top of side wall 11 to the top of first securing means 17. In another embodiment (FIG. 4C), sloped inner face 18″ extends from the bottom surface 16′ to almost the first securing means at the top of sidewall 9. In another embodiment (FIG. 4D), sloped inner face 18″′ extends from the upper end of first securing means 17 to the inner face 16i′ of the bottom surface 16.

As seen in FIGS. 5A-5D, the sloped inner faces 18 may be adapted for use with rectilinear receptacles 8 by means of a sloped insert 70. Rectilinear receptacles 8 generally comprise a base 12′ comprising four side walls 14′ and a bottom surface 16′, a lid (not shown) to cover the base 12′ and a cooling chamber defined by the lid and the base 12′, adapted to receive a thermal agent (not shown). At least one insert 70 is placed within the chamber against at least one of the vertical inner faces 18′ of side walls 14′. Insert 70 creates a slope, akin to the sloped inner face 18 of side wall 18 of the receptacle 10, so that the thermal agent is forced to be in thermal contact with object 22 continuously during use. Insert 70 may be a triangular prism with three pair wise adjacent quadrilateral faces and two non-adjacent triangular faces. The insert can comprise polypropylene or polystyrene or any other suitable thermal insulating material. It should be noted that the insert can be used to provide additional insulation for the object when the object has been retrieved from a −70° Celsius freezer and there is no dry ice available to put in one of the gaps.

In another aspect, the receptacles described herein may form part of an apparatus that can be used to prepare frozen tissue samples. The freezing apparatus further comprises a freezing platform (i.e. object 22) that is placed within the base, which is adapted to receive the freezing platform 22. Once the freezing platform 22 has been cooled by the thermal agent 60, it acts as a heat sink to cool or freeze any object that is placed in thermal contact with it. The freezing platform 22 comprises a flat freezing surface 23, and several holes 25 (only one of which is labeled for simplicity) as seen in FIG. 1. The holes 25 can extend from the top to the bottom of the freezing platform 22 or extend partway through the freezing platform 22.

The apparatus further comprises a sample receptacle 40 for holding a tissue sample and embedding material. The sample receptacle 40 includes a well 42 with a flat base for receiving the tissue sample and the embedding material, and flanges 44. The flat bottom of the well 42 acts as a conforming plane for tissue flattening. The flanges 44 accommodate any overflow of the embedding material, pressing the embedding material into the chuck grooves for forming a better bond. Any embedding material that overflows simply hardens when it freezes and can be later trimmed and removed. The flanges 44 also provide ease of handling while a medical technologist prepares the frozen tissue sample. The flanges 44 also ensure that the conforming plane and chuck face are frozen parallel to each other. The flanges 44 do not have to be of equal size.

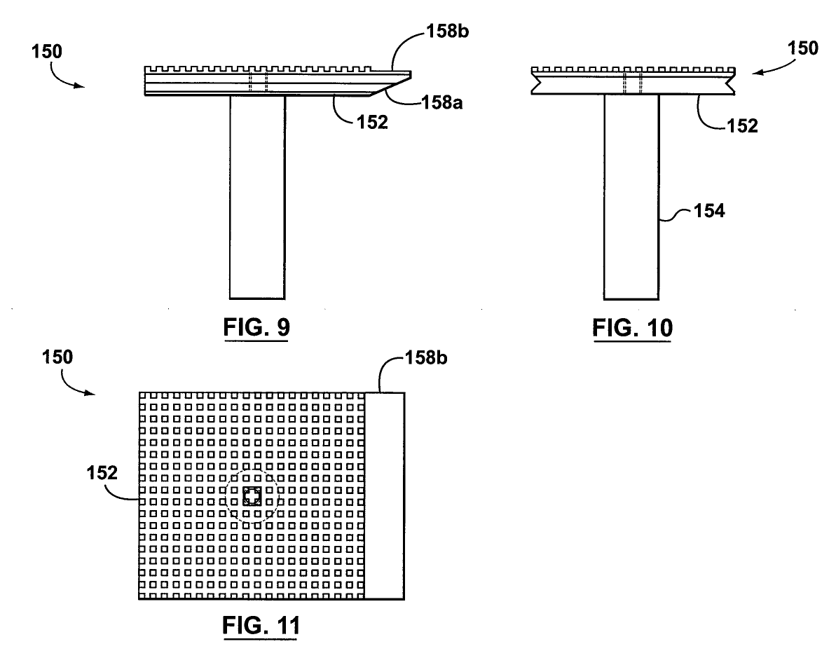

The freezing apparatus further comprises a chuck 50 having a top portion 52 and a post 54 mounted opposite the top portion 52. The top portion 52 can be a disc, but in other embodiments can be a rectangle, a square (as shown for chuck 50′) or any other suitable shape. The upper surface 56 of top portion 52 may be textured and may include a pattern of small grooves or cross-hatches (see FIGS. 9-11) that provides a “gripping surface” for the embedding material when it freezes. However, those skilled in the art know that the textured surface of the top portion 52 of the chuck 50 can be considered to be oriented in a plane. The chuck 50 is used with the sample receptacle 40 for preparing the frozen tissue sample. The upper surface 56 of the top portion 52, when parallel to the flanges 44, ensures that the sample tissue and upper surface 56 are parallel to each other. This is accomplished by placing the chuck 50 on top of the sample receptacle 40, after the sample tissue and embedding material have been added to the sample receptacle 40, so that the flanges 44 lie flat against the upper surface 56. Further, the holes 25 on the freezing platform 22 are sized slightly larger than the post 54 of the chuck 50 so that the chuck 50 can be inverted and inserted at the top of the freezing platform 22 to increase the contact area between the chuck 50 and the freezing platform 22 to further accelerate the freezing process.

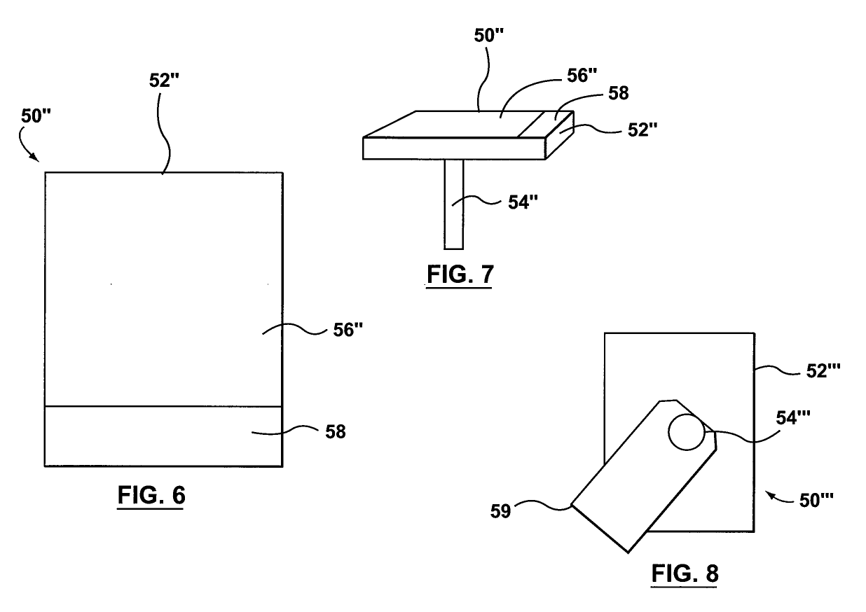

Referring now to FIGS. 6 and 7, shown therein are top and perspective views of a chuck 50″. The upper surface 56″ of the chuck 50″ includes an area 58 suitable for marking. This marking area can be used for example to write, etch or affix information relating to the processed tissue samples. The area 58 is covered with any suitable material for this purpose. Alternatively, a label may be affixed to the area 58. Alternatively, the area 58 can be located on the lower surface (not shown) of the chuck 50″.

Referring now to FIG. 8, shown therein is a bottom view of an alternative embodiment of a chuck 50″′ with a tag or label 59. The tag 59 can be added or mounted to the chuck 50″′ by attaching the tag 59 to the post 54″′. The tag 59 can have an aperture such that it is placed around the post 54″′. Alternatively, the tag 59 can be otherwise mounted or attached to the post 54″′ such as by attachment to the side of the post 54″′ with an adhesive for example. The tag 59 is suitable for marking and can be used to write or affix information.

Referring now to FIGS. 9-11, shown therein are side, end and top views of another alternative embodiment of a chuck 150. The chuck 150 includes two areas 158a and 158b that are suitable for marking. In this case, area 158a is slanted. These marking areas can be used for example to write, etch or affix information relating to the processed tissue samples. Accordingly, at least one of the areas 158a and 158b is covered with any suitable material for this purpose. The sides of the chuck 150 have an indented groove to facilitate gripping (with tongs, forceps etc.). The outside dimensions and shape of the chuck 150 can be selected to closely approximate the outside dimensions and shape of the sample receptacle 40 which facilitates orientation of the sample receptacle 40 and chuck 150 when they are joined. The upper surface of the chuck 150 is textured to increase adhesion during freezing while the lower surface is flat and smooth in order to facilitate heat transfer between the chuck 150 and the freezing platform 22.

In the various embodiments described herein, the sloped inner faces can be formed integrally with a corresponding side wall (see FIG. 1A for example). Alternatively, the sloped inner face can be provided by a side wall that has a vertical inner face and an insert having a corresponding vertical face and an opposing sloped face (as shown in FIGS. 5A and 5C). Furthermore, the sloped inner faces can be considered to slope towards the middle of the receptacle and the sloped outer faces can be considered to slope away from the middle of the receptacle. In addition, in embodiments in which a side wall has both a sloped inner face and a sloped outer face (as shown in FIGS. 1B and 1C), the slopes can be considered to be in opposite directions.

It should be understood that various modifications can be made to the embodiments described and illustrated herein, without departing from the embodiments, the general scope of which is defined in the appended claims.

1. A receptacle for freezing, cooling or maintaining the temperature of an object comprising:
a base comprising a bottom surface and side walls and being adapted to receive the object, the bottom surface and side walls having an outer face and an inner face, at least one of the inner faces on the side walls being sloped at a first angle greater than 90° relative to the bottom surface, and at least one of the outer faces of the side walls being vertical or sloped at a second angle less than 90° relative to the bottom surface; and
a lid for covering the base,
wherein the base and the lid define a chamber and at least one portion of the chamber defined by the object and the at least one sloped inner face of the side walls is adapted for receiving and maintaining a thermal agent in contact with the object during use.

2. The receptacle of claim 1, wherein the base comprises four side walls with each side wall having a sloped inner face.

3. The receptacle of claim 1, wherein the first angle of the sloped inner face is between about 120° and about 160°.

4. The receptacle of claim 1, wherein the first angle of the sloped inner face is between about 130° and about 150°.

5. The receptacle of claim 1, wherein the second angle of the sloped outer face is between about 40° and 90°.

6. The receptacle of claim 1, wherein the inner face of the bottom surface comprises bottom shoulders for receiving the object.

7. The receptacle of claim 6, wherein the bottom shoulders have a height so that the upper surface of the object is at or below the uppermost portion of the at least one sloped wall.

8. The receptacle of claim 1, wherein the lid comprises a first surface and a second surface and the base comprises a first securing means and the first surface of the lid and the second surface of the lid comprise complementary second securing means and third securing means respectively for releasably engaging the first securing means when either the first surface of the lid or the second surface of the lid is placed on the base.

9. The receptacle of claim 8, wherein the first surface of the lid is adapted to cover the base and to provide for a space between the object and the first surface of the lid, and wherein the second surface of the lid is adapted to cover the base and to restrict the space between the object and the second surface of the lid.

10. The receptacle of claim 8, wherein at least one of the surfaces of the lid acts as a tray.

11. The receptacle of claim 8, wherein at least one of the surfaces of the lid acts as working platform.

12. The receptacle of claim 1, further comprising an insert made out of a thermo-insulating material to fill the space between the object and one of the side walls or the lid.

13. The receptacle of claim 12, wherein the insert has an upper surface which lies at or below the upper surface of the object.

14. The receptacle of claim 1, wherein the object has a thermal inertia that can be maintained through continuous contact with the thermal agent.

15. The receptacle of claim 14, wherein the object is a freezing platform.

16. The receptacle of claim 1, wherein the object is a freezing platform having one of a rectangular, elliptical and circular shape.

17. The receptacle of claim 1, wherein the receptacle is integrally formed from a thermo-insulating material.

18. The receptacle of claim 1, wherein the at least one sloped inner face is formed integrally with a corresponding side wall.

19. The receptacle of claim 1, wherein the receptacle further comprises a vertical side wall with a vertical inner face and a sloped insert with a corresponding vertical face placed adjacent to the vertical side wall and an opposing sloped face to provide the at least one sloped inner face.

20. The receptacle of claim 1, wherein at least one of the surfaces of the lid is covered by a material that is suitable for serving as a cutting board.

21. A lid for covering the base of a receptacle, said lid comprising a first surface and a second surface, wherein both the first and second surfaces of the lid are designed to cover the base of the receptacle.

22. The lid of claim 21, wherein the base of the receptacle comprises a first securing means, and the first side and the second surfaces of the lid comprise a complementary second and third securing means sized for releasably engaging the first securing means when either the first surface of the lid or the second surface of the lid is placed on the base.

23. The lid of claim 22, wherein the first and second surfaces of the lid have different heights for providing different sized chambers depending on the surface that faces the receptacle when the lid is placed on the receptacle.

24. The lid of claim 21, wherein the lid is integrally formed from a thermo-insulating material.

25. An apparatus for preparing a frozen tissue sample from an excised tissue sample, wherein the apparatus comprises:
the receptacle as claimed in claim 1;
a freezing platform having a flat freezing surface;
at least one sample receptacle for receiving the excised tissue sample; and
at least one chuck.

26. The apparatus of claim 25, wherein the object freezing platform has a rectangular, elliptical or circular shape.

27. A chuck for preparing tissue samples, said chuck comprising:
a top portion having an upper surface and a lower surface; and
a post mounted on the lower surface of the top;
wherein the top portion comprises an area on at least one of the upper and lower surfaces suitable for marking information, and the dimensions of the top portion approximately match the outer flange dimensions of a sample receptacle.

28. The chuck of claim 27, wherein the chuck further comprises a groove around at least a portion of the circumference of the top portion.

29. A tag for mounting on or attaching to a chuck, wherein said tag is suitable for marking information.
